(19) United States
(12) Patent Application Publication
(10) Pub. No.: US 2003/0132726 A1
(43) Pub. Date: Jul. 17, 2003

(54) Admittance enhancement in force feedback of dynamic systems

(76) Inventors: Mark E. Dohring, Lockport, NY (US); Wyatt S. Newman, Cleveland Hts., OH (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/272,376

(22) Filed: Oct. 16, 2002

Related U.S. Application Data
(60) Provisional application No. 60/330,101, filed on Oct. 16, 2001.

(51) Int. Cl. H02K 23/18

(52) U.S. Cl. 318/437

(57) ABSTRACT

A mechanical filter and control system combination for a robot or manipulator is provided. The control system directs movement of the manipulator based on feedback of sensed contact force on the manipulator. The mechanical filter is arranged between the force sensor and the end effector of the manipulator to perform positive real compensation of the admittance response of the manipulator produced by just the force feedback control system. The mechanical filter can consist of a spring and a damper arranged in parallel.

### CROSS-REFERENCE TO RELATED PATENT APPLICATIONS

This patent application claims the benefit of U.S. Provisional Patent Application No. 60/330,101, filed Oct. 16, 2001, the disclosure of which is incorporated herein by reference.

### FIELD OF THE INVENTION

This invention pertains to robots, and more particular, to force-controlled robots.

### BACKGROUND OF THE INVENTION

For robots performing contact tasks, it is generally important that the contact operations are gentle, yet rapid. In the history of force-control research, gentleness has been demonstrated in many laboratories through the use of feedback of sensed contact force. [Daniel E. Whitney, “Historical perspective and state of the art in robot force control,” The International Journal of Robotics Research, vol. 6, no. 1, pp. 3-14, Spring 1987]. However, the speed of interaction in force-controlled robot contact tasks has typically been unacceptably slow, by industry standards. Unfortunately, there has not existed a uniform benchmark by which to compare the performances of various robots and controllers in contact operations, so the terms “gentle” and “rapid” have been left undefined.

“Impedance control” has been proposed as a means to synthesize controllers and to interpret robot dynamics. [Neville Hogan, “Impedance control: An approach to manipulation: Parts I, II and III-theory, implementation, and applications,” ASME Journal of Dynamic Systems Measurement, and Control, vol. 107, pp. 1-24, March 1985]. In this context, a robot's dynamics may be described, for example, by a (matrix) mass, (matrix) damping, and (matrix) stiffness. These components combine to produce an impedance function, Z, which may be expressed as F/ν as a function of frequency. An alternative representation is the admittance function, Y: the velocity of a robot's end effector in response to environmental forces applied to the end effector. Using the admittance function, which may be displayed for the linear SISO case as a Bode plot, we can roughly state that a larger admittance (at any frequency) is more desirable from the viewpoint of speed and gentleness.

Consider, for example, the task of following a sinusoidal contour using a light force, as suggested by FIG. 1. The contact force exerted by the follower in this example is:

F_{z}=−M\ddot{z}−B\dot{z}+K (z₀−z)

where

z(t)=zₚₑₐₖ * sin(ωt)

Larger values of ω correspond to faster tracking along the hypothetical sinusoidal surface. At low speeds, the contact force is due almost exclusively to the spring stiffness and stretch, and at high speeds the contact force is dominantly due to inertial effects. For a robot performing high-speed tracking, it is important to minimize the inertial effects. Thus, maximizing the admittance function (at least at the higher frequencies) is desirable for improving performance at higher speeds.

A more extreme but nonetheless common case is approach to initial contact. The magnitude of the impact force on contact depends on both the impedance of the environment and the admittance of the robot—particularly in the high-frequency range. If the robot admittance is higher, the impact force will be lower.

More generally, if one can model the dynamics of the environment in the context of an interaction task, and if one has a complete characterization of a robot in terms of its apparent end-point admittance, then the contact-force profile that results from a hypothetical interaction can be derived. In general, if one robot has an admittance function that is greater than that of the second robot, the robot with the larger admittance will perform the same contact task with similar forces. In terms of mechanical design and control system design, an optimization objective is to maximize the resulting end-point admittance function.

One successful design approach that has enabled lower impact forces and higher assembly speeds is the use of a passive wrist compliance, specifically a Remote Center of Compliance. [D. E. Whitney, “Force feedback control of manipulator fine motions,” ASME Journal of Dynamic Systems, Measurement, and Control, 1977]. From the admittance viewpoint, such a device increases the robot's end-point admittance, particularly at higher frequencies. This relatively simple solution has been effective in industry, in those instances where the passive kinematics are successful in specific assemblies. It would be desirable to make this capability more general through programmable admittance shaping.

Programmable modulation of contact-point impedance, including apparent inertia, has also been proposed. It was subsequently realized, however, that there are fundamental limits to how much the inertial effects can be modulated by control. Theory has been presented explaining the observed phenomenon that apparent mass reduction through feedback was limited to roughly 50% attenuation. [J. E. Colgate, The Control of Dynamically Interacting Systems, Ph.D. thesis, Massachusetts Institute of Technology, Cambridge, Mass., August 1988].

Recognizing the fundamental limitation of mass modulation through feedback, Natural Admittance Control (NAC) has been proposed, and its success has been demonstrated on a variety of industrial robots performing a variety of industrial assemblies [Wyatt S. Newman, “Stability and performance limits of interaction controllers,” Transactions of the ASME Journal of Dynamic Systems, Measurement and Control, 1992; D. Morris, R. Hebbar, and W. Newman, “Force-responsive robotic assembly of powertrain components,” in Proceedings of the IEEE International Conference on Robotics and Automation,, 2001, vol. 1, pp. 325-330]. However, this control approach achieved its results primarily by suppressing Coulomb friction while avoiding any attempt at modulation of inertia. To achieve higher speeds in contact operations, the apparent end-point inertia must be reduced.

### BRIEF SUMMARY OF THE INVENTION

In view of the foregoing, to enhance the dynamic performance of systems performing contact operations, the present invention provides a mechanical filter/control system combination for a manipulator or robot that achieves the objective of enhancing the end-point admittance function while offering the strong stability virtues of a passive end-point admittance.

In automating the assembly of components, the speed and gentleness of the assembly are key performance measures. Speed is typically measured by the cycle time to complete the assembly. Gentleness is often measured by the peak contact (or impact) force between the mating parts of the assembly. Excessive force can damage the part(s), leading to immediate or early failure. In the case of complex assemblies, such as vehicle transmissions, the early failure of a single component can lead to the costly failure of entire transmission, so consistency of gentleness is important.

The present invention can lead to dramatic improvement in both the speed and gentleness of assembly operations. Many force-controlled assembly methodologies, including Natural Admittance Control, are limited in the apparent inertia that they can achieve. This limitation is often approximately the actual inertia of the component and end effector. The disclosed invention allows the apparent inertia achieved by the controller to be greatly reduced, often by an order of magnitude or more.

The performance improvement can be intuitively grasped by imagining the improvements in speed and gentleness achievable in assembling five pound components versus assembling fifty pound components. The lighter component can be moved more quickly, is more easily “tweaked” into a tight fit, and generates much lower impact forces on contact compared to the more massive component.

### BRIEF DESCRIPTION OF THE DRAWINGS

FIG. 1 is a schematic drawing of a spring-loaded contour follower.

FIG. 2 includes Bode plots of a pair of exemplary admittance functions or plants.

FIG. 3 includes Bode plots of the exemplary admittance functions or plants illustrating the real part of admittance responses with the lower graph having an expanded y-axis.

FIG. 4 is a graph of the exemplary admittance functions or plants in simulated contact with a spring environment showing the velocity response to an impulse force impressed at the plant/environment interface.

FIG. 5 is an exemplary single resonance manipulator model from which the admittance functions or plants of FIGS. 2-4 are based.

FIG. 6 includes Bode plots illustrating the admittance of an exemplary filtered plant according to the invention in comparison with the exemplary non-passive and passive plants on which FIGS. 2-4 are based and showing how the exemplary filtered plant retains the higher admittance of the non-passive plant, yet is now passive itself.

FIG. 7 is a drawing of a rotational single axis experimental test rig or system.

FIG. 8 includes Bode plots of the admittance response of the test system of FIG. 7 under implicit force control.

FIG. 9 includes Bode plots showing the resulting admittance of the test system of FIG. 7 when Natural Admittance Control is employed to reject system friction, while setting the controlled inertia near the actual value.

FIG. 10 includes Bode plots showing the resulting admittance of the test system of FIG. 7 when Natural Admittance Control is employed to reject system friction, while setting the target inertia to 0.01 of controlled inertia setting used in connection with FIG. 9.

FIG. 11 includes Bode plots showing the resulting admittance of an exemplary mechanical filter of the test system of FIG. 7.

FIG. 12 includes Bode plots showing the resulting admittance of the test system of FIG. 7 when Natural Admittance Control and the exemplary filter of FIG. 11 are employed with the target inertia less than actual by almost two orders of magnitude. The passive response of the test system of FIG. 7 using only Natural Admittance Control is also shown for comparison purposes.

FIG. 13 is a block diagram of an exemplary force feedback controller.

FIG. 14 is a schematic diagram of an exemplary single degree of freedom manipulator utilizing a mechanical filter and force-feedback control in accordance with the present invention.

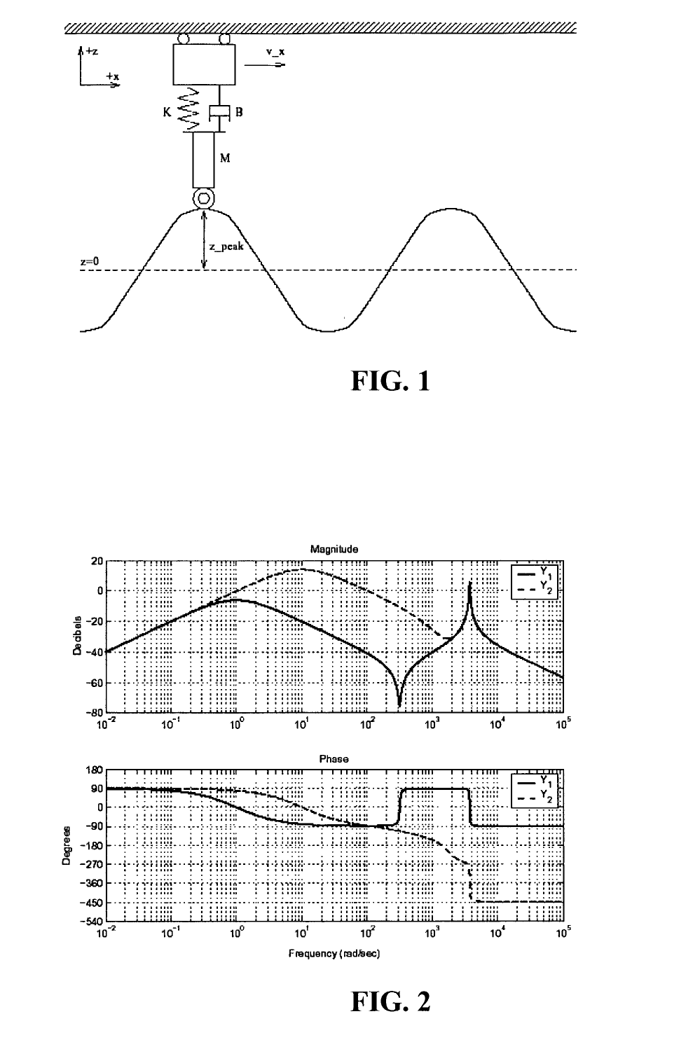

### DETAILED DESCRIPTION OF THE INVENTION

In the following description, an end-point admittance function will be used as a metric for interaction performance, which includes considerations of both gentleness and speed. With respect to this metric, a general technique for achieving dramatically better performance of controlled, dynamically interacting systems is shown. The approach uses a coordinated combination of mechanical filtering and force feedback to achieve orders of magnitude improvement over what is achievable with force feedback alone.

More particularly, a limitation of high-speed contact operations, including robotic assembly, is the magnitude of contact forces resulting from inertial effects. Directly attempting to reduce the apparent inertia of interacting systems through force feedback results in instability. According to the present invention, a mechanical filter can be introduced to alter the open-loop system dynamics, making feedback much more effective. Experimental results have shown a reduction in apparent inertia by nearly two orders of magnitude when using this approach.

This technique is a natural evolution of prior efforts in “soft sensors,” the “series elastic actuator” and the passivity perspective of interaction dynamics [S. D. Eppinger and W. P. Seering, “On dynamic models of force control,” in Proceedings of the IEEE International Conference on Robotics and Automation. IEEE, April 1986, pp. 29-34]; [Matthew Williamson, “Series elastic actuators,” M.S. thesis, Massachusetts Institute of Technology, 1995; Gill A. Pratt and Matthew Williamson, “Series elastic actuators,” in Proceedings of IROS, Pittsburgh, Pa., 1995; J. E. Colgate, The Control of Dynamically Interacting Systems, Ph.D. thesis, Massachusetts Institute of Technology, Cambridge, Mass., August 1988]. These prior efforts were not able to achieve the performance of the present invention. The series elastic actuator, in which the device's interaction port is isolated from a displacement actuator by a mechanical spring, has demonstrated highly desirable interaction dynamics, and this design is analogous to the present approach. However, it will be shown that damping in the series elastic actuator design is crucial to its performance and implications for passivity. This requirement will be made explicit.

Theoretical limits to achievable force-feedback gains in terms of passivity are known. In this analysis, the control inputs to a dynamic system are frozen; the end effector (or port of dynamic interaction with the environment) is excited with externally applied forces. The resulting end-point velocities are recorded, and the functional relationship between applied force and velocity response is identified. In the linear case, this is a transfer function from force to velocity as a function of frequency, which is the equivalent driving-point, or end-point admittance of the controlled system. For both the linear and nonlinear cases, a desirable relationship is that of a passive system. If the end-point admittance is passive, then the following advantages follow: (1) The system will be stable in contact with any passive environment (linear or nonlinear) and (2) The system will be stable in contact with an arbitrary number of additional robots provided each of the contacting robots also has a passive admittance at the contact point.

Although applicable to both linear and nonlinear dynamics, the following description will focus on the linear case. A linear passive system can be recognized in terms of its admittance function, Y(s). The system is passive if and only if the admittance function is positive real. A rational function of one complex variable, s, with real coefficients is positive real if it meets the following criteria. [Ernst A. Guilleman, Synthesis of Passive Networks, John Wiley & Sons, Inc. 1957].

(1) It is analytic in the right-half s-plane.

(2) [symbol] {Y(s)≧0, when [symbol] {s}=0

(3) Any j-axis poles are simple and have positive real residues.

FIG. 2 shows the Bode plots of two admittance functions:

$${Y}_{1} ( s ) = \begin{matrix}\frac{142.857 s ( s + 657.1 )}{( s + 667.4 ) ( {s}^{2} + 1.996 s + 0.998 )} \times \\ \frac{( {s}^{2} + 16.842 + 1.021 \times {10}^{5} )}{( {s}^{2} + 75.98 s + 1.439 \times {10}^{7} )}\end{matrix}$$

$${Y}_{2} ( s ) = \begin{matrix}\frac{142.857 s ( s + 2114 )}{( s + 646.9 ) ( s + 11.41 ) ( s + 9.023 )} \times \\ \frac{( {s}^{2} - 1442 s + 3.174 \times {10}^{6} )}{( {s}^{2} + 75.98 s + 1.439 \times {10}^{7} )}\end{matrix}$$

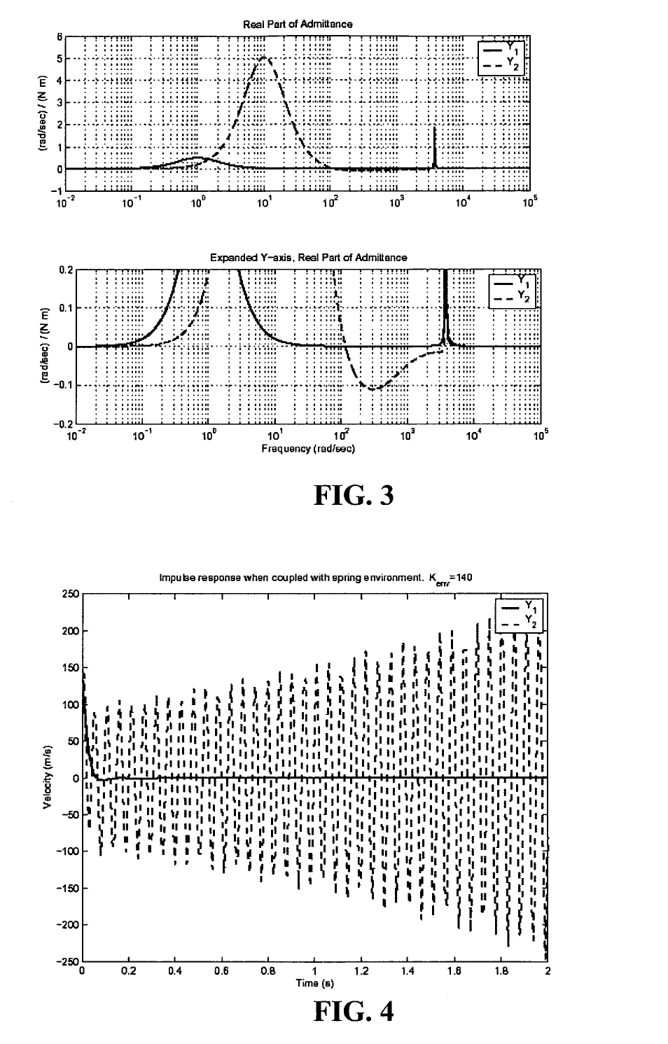

The first function, Y₁, which has phase between +90 degrees and −90 degrees (which indicates that its real part is always positive on the j-axis) is passive. There are not poles or zeros in the right half plane, nor are there any on the j-axis. The second function, Y₂ is not passive, as indicated by the large negative phase shift at high frequencies. In fact, this large phase shift reveals the presence of a pair of zeros in the right half plane. FIG. 3 shows that the real part of Y₂ is not passive, there exists some passive environment that will lead to instability in contact with this plant. FIG. 4 shows the result of plants Y₁ and Y₂ interacting with an environment impedance of

$$Z ( s ) = \frac{140}{s}$$

which is the impedance of a spring with a constant of 140 N/m. In this time-domain simulation, it is clear that Y₁ is stable whereas Y₂ is not.

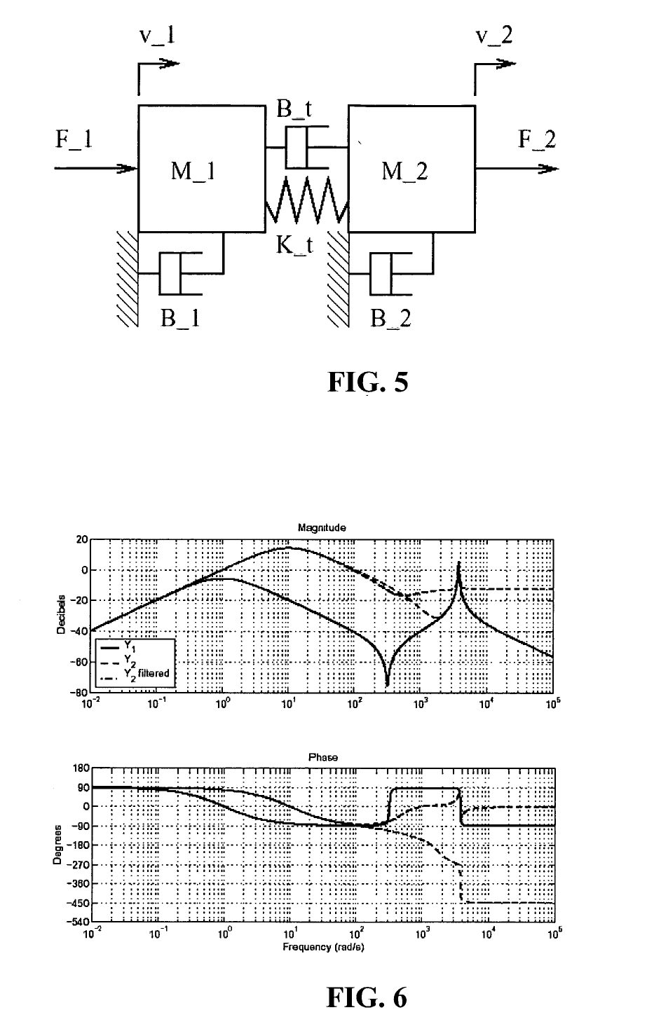

From the passivity perspective, we can observe the effects of high-gain force feedback. Plants Y₁ and Y₂ in FIGS. 2 through 4 are based on the dynamics of the system shown schematically in FIG. 5, consisting of two masses, one spring, and three dampers, modeling a single degree-of-freedom manipulator with a single resonance. Natural Admittance Control was implemented for both plants, applying actuator force, F₁, to mass, M₁, and using velocity, v₁, and environment force, F₂ for feedback. The target inertia for plant, Y₁ is a light over estimate (11%) of the total plant mass M₁+M₂. The target for plant, Y₂, is set to 0.01 times the target for plant, Y₁, which represents a target that is almost two orders of magnitude smaller than the actual plant inertia. The plant mass values were deliberately chosen to be similar to the values present in the experimental test rig used for the validation tests in section V. The NAC controllers for both plants were set to reject the effects of dampers B₁ and B₂ and modeled the system as a single inertia with no resonance for control purposes. The resulting closed-loop admittances, Y₁ and Y₂ were derived from the two controllers applied to the physical plant shown in FIG. 5.

From FIG. 2, it is clear that plant Y₂ has a much higher admittance, which is desirable in terms of contact operation performance. However, since the closed-loop plant is negative real in the range of frequencies from 115.8 rad/s to 3547 rad/s, the plant goes unstable in contact with some passive environments. If it were possible to provide compensation resulting in adding sufficient positive real offset to the plant, the resulting system may achieve passivity while retaining its desirably high admittance.

According to the present invention, a mechanical filter can be used to perform positive-real compensation. Specifically, a filter consisting of damper and spring in parallel can be inserted between the environment and the end-point of the controlled plant (robot). Feedback is performed using only the filtered contact forces between the system and the environment. For a parallel spring damper combination, the dynamics of this 2-port system are described by the impedance matrix

$${Z}_{filt} = [ \begin{matrix}\frac{{B}_{s} + K}{s} & \frac{{B}_{s} + K}{s} \\ \frac{{B}_{s} + K}{s} & \frac{{B}_{s} + K}{s}\end{matrix} ]$$

where B and K are the damping and stiffness, respectively. Note that this system has no admittance matrix, since the impedance matrix is singular. Indeed, all of the terms of the impedance matrix are identical. Terminating port 1 of this 2-port with the robot's impedance and solving for the combined impedance looking into port 2, we get (omitting the arguments for clarity)

$${Z}_{2} = \frac{{Z}_{22} {Z}_{robot}}{{Z}_{robot} + {Z}_{11}}$$

Inverting this to get the combined robot/filter admittance yields

$${Y}_{2} ( s ) = \frac{1}{{Z}_{22}} + {Y}_{robot}$$

Which is simply the robot's end-point admittance plus the admittance at port two of the mechanical filter with port one held fixed.

On the j-axis, the filter's real part is

$$ℜ ( Y ( jω ) ) = \frac{B {ω}^{2}}{{B}^{2} {ω}^{2} + {K}^{2}}$$

which is always positive wand approaches

$$\frac{1}{B}$$

at high frequencies, reaching one-half this value at a frequency of

$${ω}_{c} = \frac{K}{B}$$

and exceeding that value at all frequencies greater than ω_{c}, As a result, the filter adds positive real compensation to the plant that is guaranteed to exceed a desired value at all frequencies exceeding a desired frequency, determined by the choice of K and B. Referring back to the real part of plant Y₂ in FIG. 3, this function becomes negative at a frequency of ω_{c}=115.6 rad/s and reaches a minimum of −r=−0.111 (rad/s)/(Nm). We choose B and K of the filter such that

$$B <= \frac{1}{2 r}$$

and K<=Bω_{c}. For our example B is 4.5 (Nm)/(rad/s) and K is 521 (Nm)/rad. The resulting combined admittance is shown in FIG. 6.

A mechanical filter inserted between a manipulator and the environment eliminates the “barrier” to reducing the apparent inertia often seen in force control. The compliance provides positional coupling between the manipulator and the environment, but it is the damping that enables the response to be passive. This distinguishes the present invention from series elastic actuators and work with soft sensors. Both the damping and the stiffness must be chosen based on the manipulator's end-point admittance function. In general, the more compensation that is required, the lower the damping and stiffness will be, but the greater the inertia reduction that will be possible.

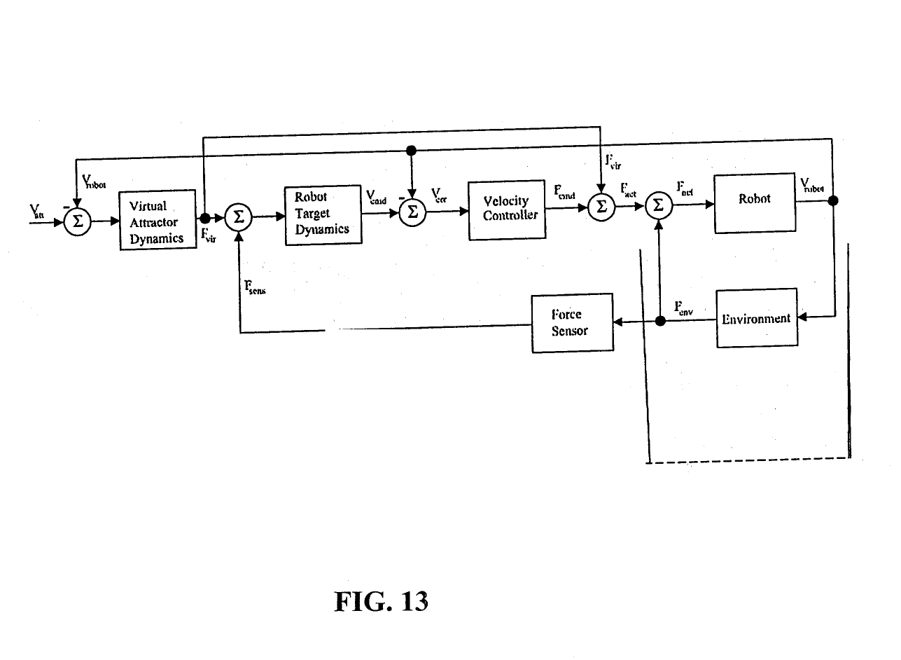

The performance of a force controlled manipulator can be made more “gentle” and “rapid” (increasing the end-point admittance) by employing a mechanical filter selected appropriately in combination with the controller design. It should finally be noted that the filter design principle does not depend on any specific controller methodology, as long as the admittance of the closed-loop system can be determined, either empirically or analytically. For example, while the present invention is described in connection with an NAC-based force feedback control, those skilled in the art will appreciate that present invention may be used to improve the stability and performance of any force feedback control algorithm. A basic block diagram of an exemplary NAC-based force feedback controller for a manipulator or robot is provided in FIG. 13.

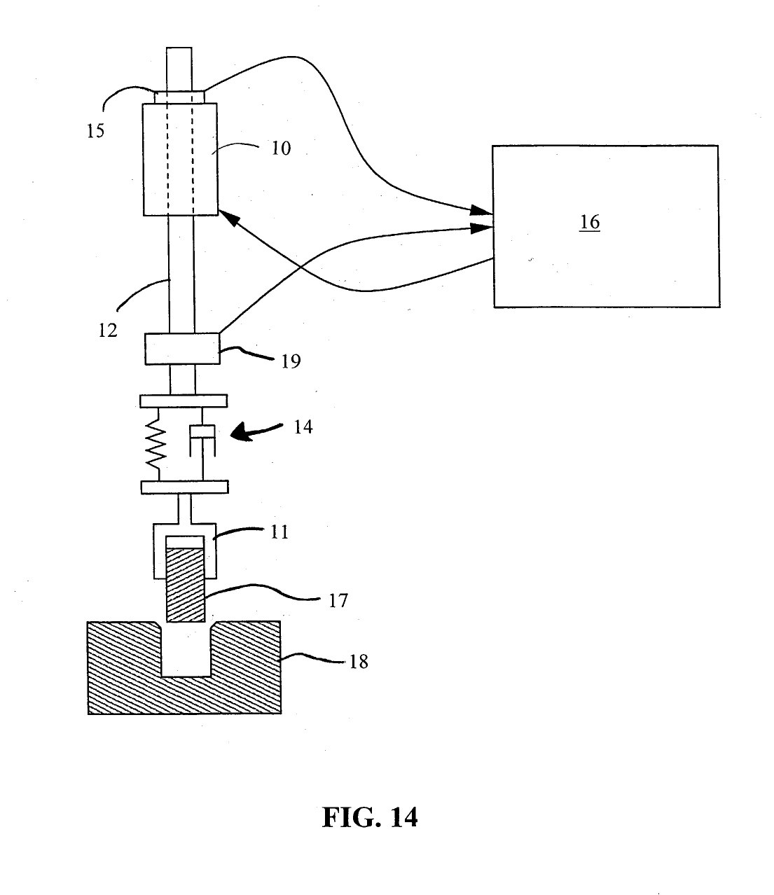

FIG. 14 illustrates schematically one way in which the present invention could be implemented in a single degree of freedom manipulator. As shown, the manipulator includes a linear actuator 10, an end effector comprising a gripper 11 at the end of a link 12 for moving a workpiece 17 relative to an environment 18, a force sensor 19 on the link 13, a mechanical filter 14 arranged in the link between the force sensor and the end effector, a position sensor 15 and a force and position feedback controller 16. The controller 16 receives signals from the position and force sensors 15, 19 and directs operation of the actuator 10.

Another exemplary device in which the present invention could be implemented is the manipulator described in commonly owned application Ser. No. 10/187,932, filed Jul. 2, 2002 naming J. Michael Stuart and Steve T. Charles as inventors. In that manipulator, the present invention could be implemented by inserting a mechanical filter in series with each positioning link. The mechanical filter could consist of a spring and a damper in parallel.

The following example further illustrates the invention but, of course, should not be construed as in any way limiting its scope.

### EXAMPLE 1

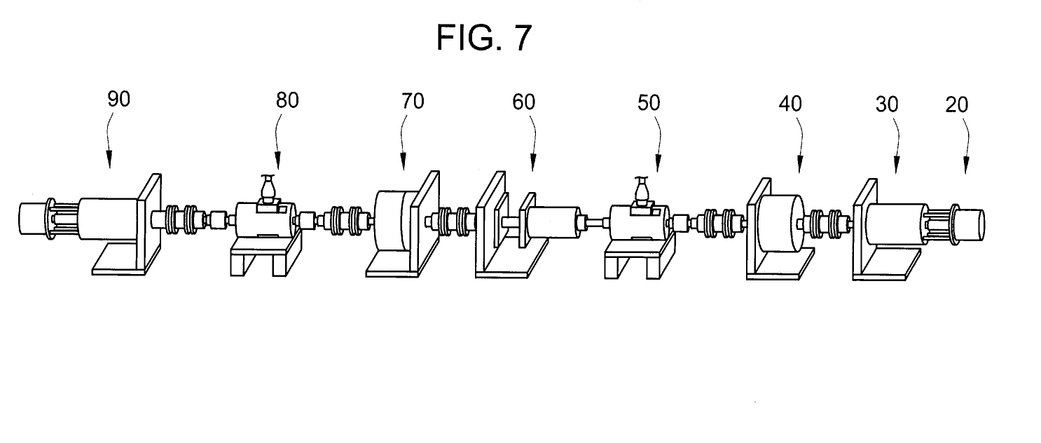

To validate this analysis and design approach, a physical experiment was performed. Specifically, experiments were performed using a rotational, single-axis test rig, shown in FIG. 7, and a rotational implementation of the mechanical filter. The test rig or system shown in FIG. 7 consists of a system encoder 20, a system motor 30, transmission 40, feedback torque transducer 50 and mechanical filter 60. Admittance is measured by the admittance encoder 70 and torque transducer 80 by exciting the system with the excitation motor 90. With the filter input locked to its input, Natural Admittance Control was implemented on the test system and a non-passive response was created by setting the target inertia to a value almost two orders of magnitude below the actual inertia. The admittance response of the system with the filter locked out was used to select the proper filter stiffness and damping values to provide sufficient real-part compensation. The admittance measurement was repeated to verify its passivity and a series of controlled impact tests were performed to assess performance.

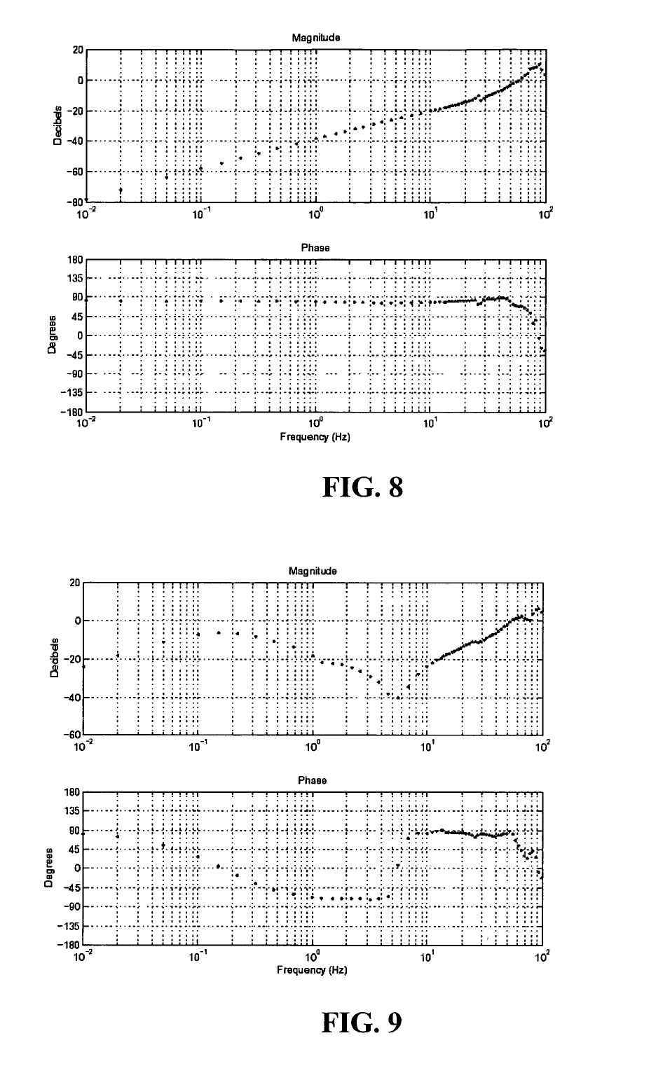

FIG. 8 shows the admittance response under implicit force control. In this experiment, the filter spring elements were replaced by rigid steel bars to lock the filter input and output together, effectively disabling it. The excitation source was unable to overcome the Coulomb friction present in the transmission and the admittance is dominated by compliances in the transmission and torque transducers (thus, this case is identical to runs where the actuator is switched off).

FIG. 9 shows the resulting admittance when Natural Admittance Control is employed to reject system friction, while setting the controlled inertia near the actual value (10% over estimate). This represents the minimum inertia achievable using Natural Admittance Control alone.

Attempting to reduce the target inertia to one one-hundredth of the final value produces the admittance shown in FIG. 10. The response is not passive.

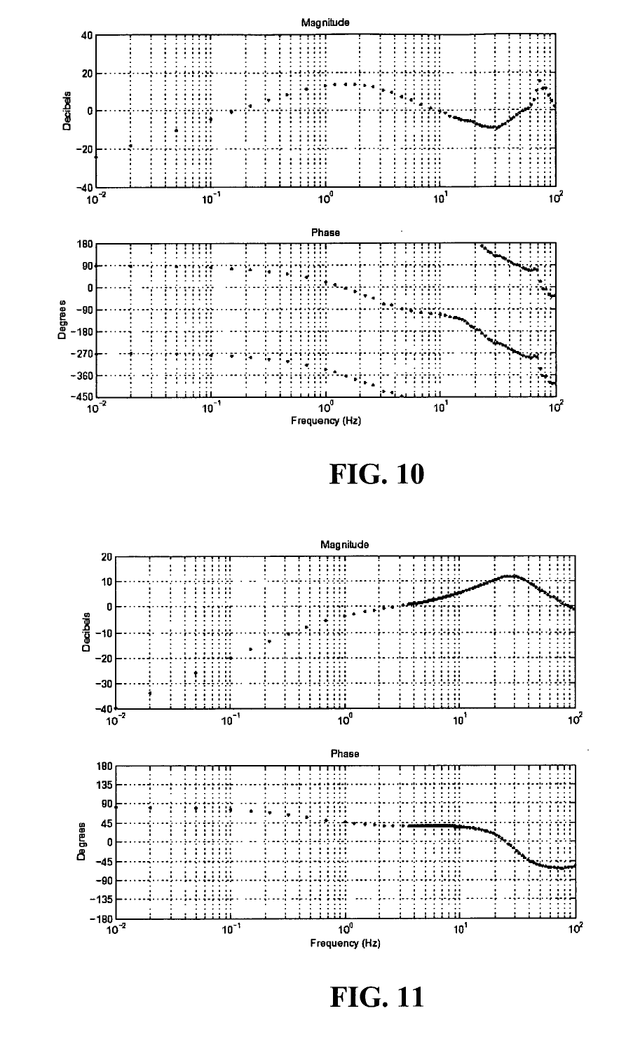

Examining the real part of the previous response led to the selection of spring and damper elements for the filter. The response of the filter is shown in FIG. 11.

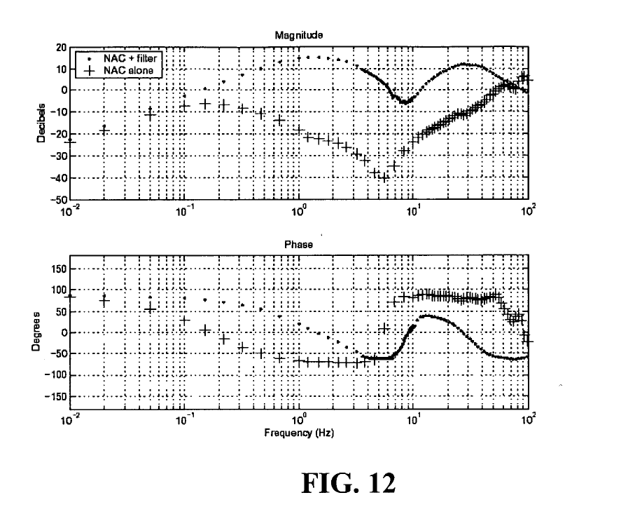

With the filter in place, the experiment with the target inertia reduced by almost two orders of magnitude over the actual inertia was repeated. The result, shown in FIG. 12, exhibits a passive admittance.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A manipulator comprising:
an arm;
an end effector supported on the arm;
an actuator operatively connected to the arm for moving the end effector with at least one degree of freedom;
a force sensor arranged on the arm for producing signals indicative of forces applied to the arm;
a controller in communication with the force sensor and the actuator, the controller directing movement of the actuator based at least in part on the signals from the force sensor; and
a mechanical filter arranged in series with the arm between the end effector and the force sensor, the mechanical filter comprising a spring and a damper arranged in parallel.
